(19) United States
(12) Patent Application Publication
(10) Pub. No.: US 2010/0215873 A1
(43) Pub. Date: Aug. 26, 2010

(54) SYSTEM FOR DISPLAY IMAGES AND FABRICATION METHOD OF DISPLAY PANELS

(75) Inventors: Yi-Chi LIAO, Zhubei City (TW); Shih-Yao LIN, Zhubei City (TW); Li-Chen WEI, Taiping City (TW)

Correspondence Address: LOWE HAUPTMAN HAM & BERNER, LLP, 1700 DIAGONAL ROAD, SUITE 300, ALEXANDRIA, VA, 22314, US

(73) Assignees: TPO DISPLAYS CORP., Miao-Li County (TW); GLOBAL DISPLAY TAIWAN CO., LTD., Taichung County (TW)

(21) Appl. No.: 12/574,944

(22) Filed: Oct. 7, 2009

Related U.S. Application Data
(60) Provisional application No. 61/104,665, filed on Oct. 10, 2008.

(30) Foreign Application Priority Data
Mar. 30, 2009 (TW) 098110377

(51) Int. Cl. B32B 3/00; B32B 27/38; B32B 27/30; B32B 5/00; C09K 19/00; B29D 11/00

(52) U.S. Cl. 428/1.33; 428/413; 428/522; 428/142; 428/336; 428/220; 216/24

(57) ABSTRACT

A system for displaying images including a display panel and a fabrication method of a display panel are provided. The display panel includes a first substrate and a second substrate opposite to the first substrate, wherein a total thickness of assembling the first and the second substrates is reduced by a thinning process, and by utilizing an acrylic-based or an epoxy acrylic-based polymer film to cover the outer surfaces of the first and the second substrates.

### CROSS REFERENCE TO RELATED APPLICATIONS

This application claims the benefit of U.S. Provisional Application No. 61/104,665, filed on Oct. 10, 2008, and priority of Taiwan Patent Application No. 098110377, filed on Mar. 30, 2009, the entirety of which is incorporated by reference herein.

### BACKGROUND OF THE INVENTION

1. Field of the Invention

The invention relates to a system for displaying images including a display panel, and more particularly to a display panel with substrates treated by a thinning process.

2. Description of the Related Art

Display devices are continually being developed toward lighter weights. In general, the glass substrate of display panels is thinned to provide display devices with lighter weights. In the conventional methods, the glass substrates are thinned by a mechanical polishing process. However, the thinning process weakens the strength of the glass substrates.

The conventional thinning process for glass substrates is performed by two mechanical polishing process steps. The first step is a rough polishing process, used to reduce a thickness of the glass substrate to a required thickness. In the first step, the surface roughness of the glass substrate becomes large, so that the light transmission of the glass substrate is reduced and the glass substrate becomes opaque. Next, the second step of the polishing process is used to reduce the surface roughness of the glass substrate, such that the transparency of the glass substrate is enhanced. However, the strength of the thinned glass substrate is reduced, thus the glass substrate is easily broken during the second polishing process step. Therefore, the thickness of the glass substrate is limited. Moreover, after the second polishing process step, the surface roughness of the glass substrate is not able to be reduced further

U.S. Pat. No. 7,294,373 discloses utilizing a metal oxide thin film to cover the surfaces of thinned glass substrates to solve the thinning process problems described previously. However, the two polishing process steps are still required, thus, still hindering further reduction in thickness of the glass substrate.

Therefore, a display panel with thin substrates is desirable, wherein the thinning process does not have the problems as described previously.

### BRIEF SUMMARY OF THE INVENTION

The present invention provides a system for displaying images including a display panel. The display panel comprises a first substrate having a first outer surface and a second substrate having a second outer surface. The second substrate is disposed opposite to the first substrate and assembled with the first substrate to obtain a total thickness, wherein the total thickness is formed after a thinning process. A transparent acrylic-based or epoxy acrylic-based polymer film covers the first outer surface and the second outer surface.

The present invention further provides a method for fabricating a display panel. The method comprises providing a first substrate having a first outer surface and providing a second substrate having a second outer surface. The second substrate is disposed opposite to the first substrate and assembled with the first substrate to form a first total thickness. A thinning process is performed to the first substrate and the second substrate, so that the first total thickness is reduced to form a second total thickness. Then, an acrylic-based or an epoxy acrylic-based polymer material is provided to coat on the first outer surface and the second outer surface for forming a transparent acrylic-based or epoxy acrylic-based polymer film.

A detailed description is given in the following embodiments with reference to the accompanying drawings.

### BRIEF DESCRIPTION OF THE DRAWINGS

The present invention can be more fully understood by reading the subsequent detailed description and examples with reference to the accompanying drawings, wherein:

FIG. 1 is a schematic cross section of an organic light emitting display panel according to an embodiment of the invention;

FIG. 2A is a schematic partial enlarged view of the dotted line circled area 2A of FIG. 1;

FIG. 2B is a schematic partial enlarged view of the dotted line circled area 2B of FIG. 1;

FIG. 3 is a schematic cross section of a liquid crystal display according to an embodiment of the invention;

FIGS. 4A-4C are schematic cross sections of a method for fabricating a display panel according to an embodiment of the invention; and

FIG. 5 schematically shows a system for displaying images including the display panel of the invention according to an embodiment of the invention.

### DETAILED DESCRIPTION OF THE INVENTION

The following description is of the best-contemplated mode of carrying out the invention. The description is provided for illustrating the general principles of the invention and is not meant to be taken in a limiting sense. The scope of the invention is best determined by reference to the appended claims.

In an embodiment of a display panel of the present invention, surfaces of thinned substrates are treated by utilizing an acrylic-based or an epoxy acrylic-based polymer film to cover the outer surfaces of the thinned substrates, such that defects on the outer surfaces of substrates produced from a thinning process are repaired and strength of the thinned substrates are enhanced.

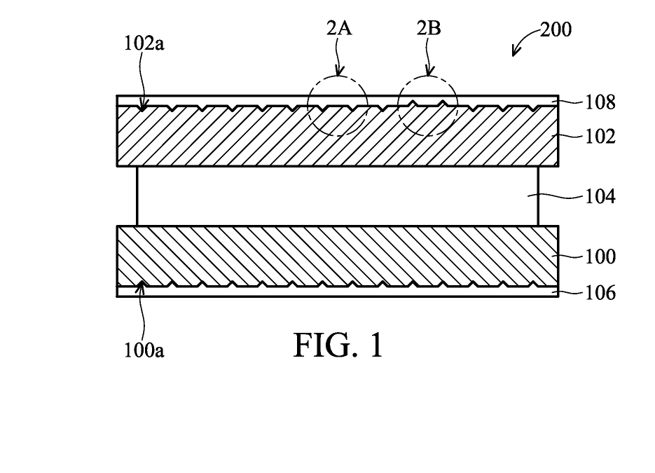

Referring to FIG. 1, a cross section of an organic light emitting display panel 200 according to an embodiment of the present invention is shown. An organic light emitting display panel 200 has a first substrate 100 and a second substrate 102 disposed opposite to each other. An organic light emitting layer 104 is sandwiched between the first substrate 100 and the second substrate 102 to form the organic light emitting display panel 200. One skilled in the art would appreciate that other elements or structures may be further disposed on inner surfaces of the first and the second substrates, for example, electrode layers and a color filter layer. In order to simplify the figures, the elements are omitted and not shown.

The first substrate 100 and the second substrate 102 are treated by a thinning process. A total thickness of assembling the first substrate 100 and the second substrate 102 can be reduced by at least 20% by the thinning process. For example, a total thickness of assembling the first substrate 100 and the second substrate 102 is about 1 mm before thinning. After the thinning process, a display panel formed from assembling the first substrate 100 and the second substrate 102 has a total thickness of about 0.2 to 0.8 mm. The thinning process may be a mechanical polishing process, a chemical etching process or other thinning processes. Through the chemical or physical treatment of the thinning process, a first outer surface 100a of the first substrate 100 and a second outer surface 102a of the second substrate 102 become rough. The first outer surface 100a and the second outer surface 102a have a roughness of peak to valley (R_{Peak to valley}) of about more than 0.25 μm. Meanwhile, surface defects are produced on the outer surfaces 100a and 102a, for example, a dimple, a scratch, a pimple or combinations thereof, so that transparencies of the first substrate 100 and the second substrate 102 are reduced and strengths thereof are also reduced.

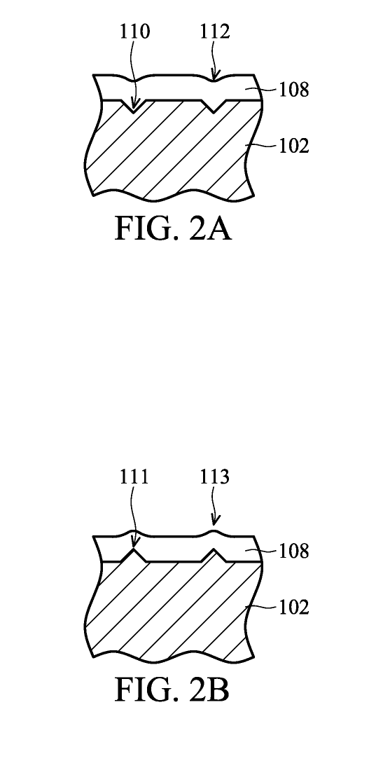

Thus, in an embodiment of the present invention, polymer films 106 and 108 are formed to cover the first outer surface 100a of the first substrate 100 and the second outer surface 102a of the second substrate 102, respectively. The polymer films 106, 108 may be a transparent acrylic-based or epoxy acrylic-based polymer. After being covered with the polymer films 106, 108, the roughness of the first outer surface 100a and the second outer surface 102a are reduced by at least 50%. Meanwhile, a width, a depth and a height of the surface defects on the first outer surface 100a and the second outer surface 102a are reduced significantly. Referring to FIG. 2, a partial enlarged view of the dotted line circled area 2A of FIG. 1 is shown. By covering a dimple 110 on the second outer surface 102a with the polymer film 108, a depth and a width of a surface defect 112 is decreased significantly. Referring to FIG. 2B, a schematic partial enlarged view of the dotted line circled area 2B of FIG. 1 is shown. By covering a pimple 111 on the second outer surface 102a with the polymer film 108, a height of a surface defect 113 is decreased significantly. Thus, a surface roughness of the thinned substrates 110 and 102 can be reduced by the polymer films. In addition, the strength of the thinned substrates also can be enhanced by the polymer films. In an embodiment, the strength of the thinned substrates can be increased by at least 35% by the polymer films of the invention.

In one embodiment of the present invention, a thickness of the polymer films 106 and 108 may be about 1.5 to 10 μm, and a light transmission of the polymer films 106 and 108 are similar to that of the first substrate 100 and the second substrate 102. For example, the first substrate 100 and the second substrate 102 have a light transmission of about 70% to 90% and the polymer films 106 and 108 have a light transmission of about 98% to 100%. In an embodiment of the present invention, a composition of the polymer film may be an oligomer, a reactive monomer, a photoinitiator and other additives, wherein the oligomer may be about 10% to 80% by weight. The oligomer may be, for example, polyester acrylic oligomer, epoxy acrylic oligomer, or polyurethane acrylic oligomer. In the composition of the polymer film, the reactive monomer may be about 10% to 80% by weight. The reactive monomer may be, for example, multifunctional acrylate. In the composition of the polymer film, the photoinitiator may be about 0.5% to 10% by weight and the other additives may be about 0 to 10% by weight. The additive may be, for example, silica (SiO₂).

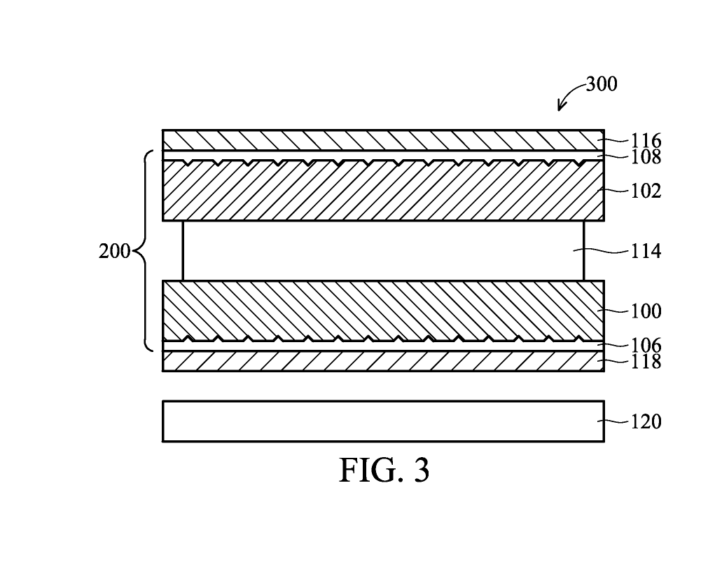

Referring to FIG. 3, a schematic cross section of a liquid crystal display 300 according to an embodiment of the present invention is shown. The liquid crystal display 300 includes a liquid crystal display panel 200. The difference between the display panel 200 and the organic light emitting display panel of FIG. 1 is that the liquid crystal display panel 200 has a liquid crystal layer 114 sandwiched between the first substrate 100 and the second substrate 102. The first substrate 100 may be an array substrate and the second substrate 102 may be a color filter substrate. In addition, a lower polarizer 118 and an upper polarizer 116 are disposed on the polymer films 106 and 108 respectively. A backlight source 120 is disposed under the lower polarizer 118 and the liquid crystal display panel 200 to complete the liquid crystal display 300.

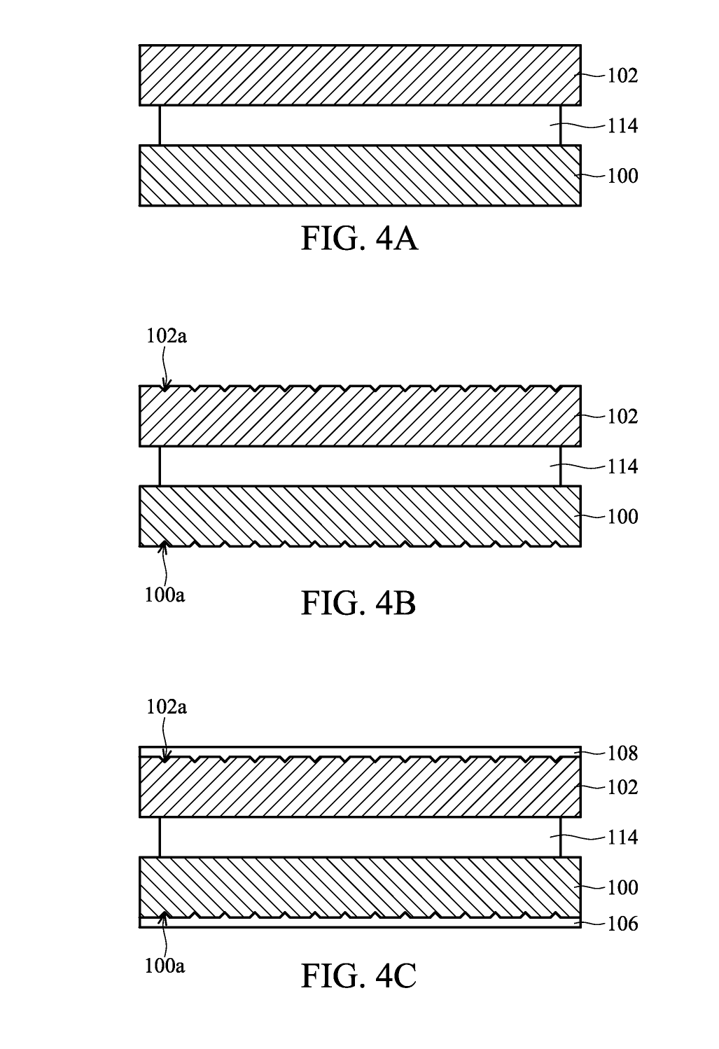

Referring to FIGS. 4A-4C, schematic cross sections of a method for fabricating a liquid crystal display panel according to an embodiment of the present invention are shown. Referring to FIG. 4A, the first substrate 100 and the second substrate 102 are provided to be oppositely assembled. The first substrate 100 and the second substrate 102 may be glass substrates. The liquid crystal layer 114 is sandwiched between the first substrate 100 and the second substrate 102, wherein the first substrate 100 and the second substrate 102 are not thinned yet. After assembling, the first substrate 100 and the second substrate 102 have a total thickness of about 1 mm.

Next, referring to FIG. 4B, the assembled first substrate 100 and second substrate 102 are thinned by a thinning process. In an embodiment of the present invention, the glass substrates are thinned by a wet etching process utilizing hydrofluoric acid (HF). After thinning, the assembled first substrate 100 and second substrate 102 have a total thickness reduced into 0.8 mm and the outer surfaces 100a and 102a thereof are rough. There is a plurality of surface defects on the outer surfaces 100a and 102a, for example, a dimple, a scratch, a pimple or combinations thereof. In the above mentioned embodiment, the two substrates are thinned after assembling. In another embodiment, the two substrates can be thinned first and then assembled.

Referring to FIG. 4C, an acrylic-based or an epoxy acrylic-based polymer material is coated on the outer surface 100a of the first substrate 100 and the outer surface 102a of the second substrate 102. Then, the polymer material is cured by an ultraviolet (UV) light irradiating and/or heating to form a transparent polymer films 106 and 108 to complete the display panel of the invention. The above mentioned coating method may be a spin coating, a scrubber coating, a roller coating or the other coating methods. The heating temperature is preferred to be lower than 160° C. The total energy of the ultraviolet (UV) light irradiating is depended on the polymer materials, which is usually about 2000 mj.

In an embodiment of the present invention, only one etching process is needed to complete thinning the substrates of the display panel. Then, the polymer films are utilized to cover the outer surfaces of the thinned substrates to repair the surface defects produced by the thinning process. Meanwhile, the roughness of the surfaces of the substrates is reduced and the transparency of the substrates is enhanced. Moreover, the strength of the thinned substrates is increased. In addition, compared with the conventional thinning processes of the substrates, the thinning process of the present invention can omit one polishing step, such that the production costs can be reduced.

The characteristics of the thinned substrates of Examples and Comparative Examples of the present invention are listed as below in Table 1. In both the Examples and the Comparative Examples, two assembled glass substrates had a total thickness of 1 mm and the total thickness was reduced into 0.8 mm after the thinning process. The polymer films of each Example had different thicknesses. In the Comparative Examples, there was no polymer film utilized to cover the substrates. The surface defects of the substrates before and after coating the polymer films were measured by a white light scattering instrument (SNU) and a surface profiler (KT-profiler). The fracture strength of the thinned substrates was measured by a dual axes breaking-resistant test of ring-on-ring (RoR) test. The measurement results are shown in Table 1.resistant test of ring-on-ring (RoR) test. The measurement results are shown in Table 1.

TABLE 1
The characteristics of the thinned substrates of the
Examples and the Comparative Examples

| | | Thickness | Depth of defect (μm) | | Width of defect (μm) | | |
|---|---|---|---|---|---|---|---|
| | | of acrylic- | Before | After | Before | After | |
| | Surface | based | coating the | coating the | coating the | coating the | Fracture |
| | defect | polymer | polymer | polymer | polymer | polymer | strength of |
| | type | film (μm) | film | film | film | film | RoR test (N) |
| Example 1 | Dimple | 2.26 | 4.90 | 1.48 | 250 | 160 | 36.04 |
| Example 2 | Dimple | 2.80 | 7.31 | 0.84 | 131 | 186 | 36.03 |
| Comparative | Dimple | 0 | 4.80 | — | 4.33 | — | 19.11 |
| Example 1 | | | | | | | |
| Example 3 | Scratch | 2.82 | 4.05 | 0 | 91 | 0 | 69.3 |
| Example 4 | Scratch | 3.09 | 7.02 | 0.89 | 123 | 122 | 140.44 |
| Comparative | Scratch | 0 | 6.01 | — | 159 | — | 51.06 |
| Example 2 | | | | | | | |

As shown in Table 1, in the Examples of the present invention utilizing the polymer films to cover the thinned substrates, the width of the dimple defects were reduced by at least 36%, the depth of the dimple defects were reduced by at least 70% and the strength of the substrates was enhanced at least 88%. In addition, the width of the scratch defects on the surfaces of the thinned substrates were reduced by at least 1%, the depth of the scratch defects were reduced by at least 87% and the strength of the substrates was enhanced at least 35%.

Thus, the display panels of the present invention have several advantages, such as repairing the surface defects of the thinned substrates and enhancing the strength of the thinned substrates. Moreover, the polishing step of the thinning process can be saved to reduce production costs.

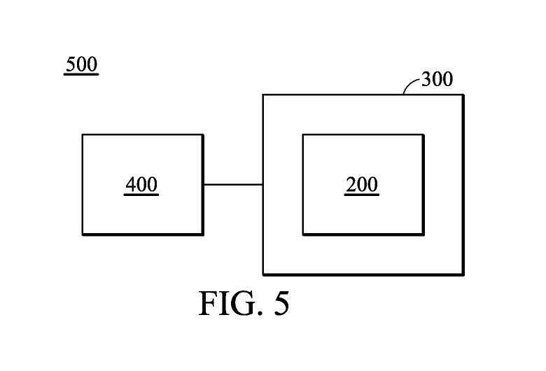

Next, referring to FIG. 5, a system 500 for displaying images including the display panel of the present invention according to an embodiment of the present invention is shown. The system 500 comprises a display 300, and the display 300 includes the display panel 200 of the present invention. The display 300 is, for example, a liquid crystal display or an organic light emitting display. The display 300 can be a part of an electronic device. In general, the system 500 for displaying images comprises the display 300 and an input unit 400. The input unit 400 is coupled to the display 300 and operative to provide input to the display 300 such that the display displays images. The electronic device can be a mobile phone, digital camera, personal data assistant (PDA), notebook computer, desktop computer, television, car display or portable DVD player.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for displaying images, comprising:
a display panel, comprising:
a first substrate having a first outer surface;
a second substrate having a second outer surface, wherein the second substrate is disposed opposite to the first substrate and assembled with the first substrate to obtain a total thickness; and
a transparent acrylic-based or epoxy acrylic-based polymer film covering the first outer surface and the second outer surface, wherein the total thickness is formed by a thinning process.

2. The system as claimed in claim 1, wherein the first outer surface and the second outer surface have a defect thereon and the defect comprises a dimple, a scratch, a pimple or combinations thereof.

3. The system as claimed in claim 1, further comprising an upper polarizer and a lower polarizer disposed on the polymer films of the first outer surface and the second outer surface respectively.

4. The system as claimed in claim 1, wherein the polymer film has a thickness of between 1.5 μm and 10 μm.

5. The system as claimed in claim 1, wherein the total thickness is 0.2 to 0.8 mm.

6. The system as claimed in claim 1, wherein the first outer surface and the second outer surface have a roughness of greater than 0.25 μm.

7. The system as claimed in claim 6, wherein the roughness is reduced by at least 50% by covering the first outer surface and the second outer surface with the polymer film.

8. The system as claimed in claim 7, wherein strength of the first substrate and the second substrate is enhanced by at least 35% by covering the first substrate and the second substrate with the polymer film.

9. The system as claimed in claim 1, wherein a composition of the polymer film comprises an oligomer, a reactive monomer, a photoinitiator and an additive.

10. The system as claimed in claim 1, further comprising a display device, wherein the display device includes the display panel, and the display device comprises a liquid crystal display or an organic light emitting display.

11. The system as claimed in claim 10, further comprising an electronic device, wherein the electronic device comprises:
the display device; and
an input unit coupled to the display device to provide input to the display device to display images.

12. The system as claimed in claim 11, wherein the electronic device comprises a mobile phone, digital camera, personal data assistant (PDA), notebook computer, desktop computer, television, car display or portable DVD player.

13. A method for fabricating a display panel, comprising:
providing a first substrate, having a first outer surface;
providing a second substrate, having a second outer surface, wherein the second substrate is disposed opposite to the first substrate and assembled with the first substrate to form a first total thickness;
performing a thinning process to the first substrate and the second substrate, so that the first total thickness is reduced to form a second total thickness; and
providing an acrylic-based or an epoxy acrylic-based polymer material, coating on the first outer surface and the second outer surface to form a transparent acrylic-based or epoxy acrylic-based polymer film.

14. The method as claimed in claim 13, wherein the thinning process comprises an etching process.

15. The method as claimed in claim 13, wherein after the thinning process step, a defect is formed on the first outer surface and the second outer surface, the defect comprises a dimple, a scratch, a pimple or combinations thereof, and the first outer surface and the second outer surface have a roughness of greater than 0.25 μm.

16. The method as claimed in claim 15, wherein a size of the defect is reduced and the roughness is reduced by at least 50% by covering the first outer surface and the second outer surface with the polymer film.

17. The method as claimed in claim 13, wherein the second total thickness is reduced at least 20% than that of the first total thickness.

18. The method as claimed in claim 13, wherein the polymer film has a thickness of between 1.5 and 10 μm.

19. The method as claimed in claim 13, wherein after forming the polymer film, a strength of the first substrate and the second substrate is enhanced by at least 35%.

20. The method as claimed in claim 13, wherein a composition of the acrylic-based or the epoxy acrylic-based polymer material comprises an oligomer, a reactive monomer, a photoinitiator and an additive
